(19) United States
(12) Patent Application Publication
(10) Pub. No.: US 2021/0339678 A1
(43) Pub. Date: Nov. 4, 2021

(54) INFORMATION PRESENTATION DEVICE, INFORMATION PRESENTATION CONTROL METHOD, AND NON-TRANSITORY COMPUTER-READABLE RECORDING MEDIUM

(71) Applicant: MITSUBISHI ELECTRIC CORPORATION, Tokyo (JP)

(72) Inventors: Daiki KUDO, Tokyo (JP); Masahiro ABUKAWA, Tokyo (JP); Takahiro OTSUKA, Tokyo (JP)

(73) Assignee: MITSUBISHI ELECTRIC CORPORATION, Tokyo (JP)

(21) Appl. No.: 17/376,481

(22) Filed: Jul. 15, 2021

Related U.S. Application Data
(63) Continuation of application No. PCT/JP2019/001628, filed on Jan. 21, 2019.

(51) Int. Cl. B60R 1/00; H04N 5/247; G06K 9/00; H04N 5/232; G06T 7/70; B60Q 9/00

(52) U.S. Cl. CPC B60R 1/00; H04N 5/247; G06K 9/00805; H04N 5/23238; G06T 7/70; B60R 2300/8093; G06T 2207/30268; G06T 2207/30201; B60R 2300/105; B60R 2300/20; B60Q 9/00

(57) ABSTRACT

An information presentation device includes: an imager to image an area around a vehicle and generate a vehicle outside image; an imager to image an inside of the vehicle and generate a vehicle inside image; a display including multiple display portions; and circuitry to recognize one or more obstacles from the vehicle outside image, generate obstacle information indicating a result of the recognition, generate, from the vehicle inside image, line-of-sight information indicating a direction of a line of sight of a driver, make a determination regarding display on each display portion based on the obstacle information and line-of-sight information, and control display on each display portion based on the determination. The circuitry causes, for each obstacle, an image including the obstacle to be displayed on one of the display portions located in a direction of the obstacle or a direction close thereto as viewed from the driver.

### CROSS REFERENCE TO RELATED APPLICATION

This application is a continuation of International Application No. PCT/JP2019/001628, filed on Jan. 21, 2019, the disclosure of which is incorporated herein by reference in its entirety.

### BACKGROUND OF THE INVENTION

### 1. Field of the Invention

The present invention relates to an information presentation device, an information presentation control method, and a non-transitory computer-readable recording medium.

### 2. Description of the Related Art

There is known a device that assists in driving by displaying, on a display means in a vehicle, an image obtained by imaging an area around the vehicle. Patent Literature 1 discloses a display device that identifies an object observed by a driver on the basis of the line of sight of the driver, and changes the type of displayed information depending on the identified observed object.

Patent Literature 1: Japanese Patent Application Publication No. 2008-13070 (see paragraphs 0021 and 0022)

The device of Patent Literature 1 has a problem that, in order to see the displayed information, the driver needs to shift the line of sight from the observed object to the display means, and when the observed object and the display means are located in different directions, it takes time to see the displayed information.

### SUMMARY OF THE INVENTION

An information presentation device of the present invention includes:

a vehicle outside imager to image an area around a vehicle and generate a vehicle outside image;

a vehicle inside imager to image an inside of the vehicle and generate a vehicle inside image;

a display including a plurality of display portions; and

an information presentation controlling circuitry to recognize one or more obstacles from the vehicle outside image, generate obstacle information indicating a result of the recognition of the obstacles, generate, from the vehicle inside image, line-of-sight information indicating a direction of a line of sight of a driver, make a determination regarding display on each of the plurality of display portions, on a basis of the obstacle information and the line-of-sight information, and control display on each of the plurality of display portions, on a basis of the determination,

wherein the determination regarding the display includes, for each of the plurality of display portions, a determination as to whether display of the vehicle outside image on the display portions is needed, and a determination regarding emphasis processing to each obstacle in the vehicle outside image on the display portion,

wherein the determination regarding the emphasis processing includes a determination as to whether emphasis is needed, and a determination of a level of emphasis, and

wherein the information presentation controlling circuitry causes, for each of the recognized one or more obstacles, an image including the obstacle to be displayed on one of the plurality of display portions that is located in a direction of the obstacle or a direction close thereto as viewed from the driver.

With the present invention, since, for each of recognized one or more obstacles, an image including the obstacle is displayed on one of the plurality of display portions that is located in a direction of the obstacle or a direction close thereto as viewed from a driver, when the driver is seeing an area around the vehicle in a certain direction, the driver need not shift the line of sight in order to see an image obtained by imaging in the same direction, and thus the time taken to see the displayed image can be reduced.

### BRIEF DESCRIPTION OF DRAWINGS

FIG. 1 is a block diagram illustrating an information presentation device of a first embodiment of the present invention.

FIG. 2 is a schematic diagram illustrating a vehicle mounted with the information presentation device.

FIG. 3 is a diagram illustrating a positional relation between a left display unit and a right display unit.

FIG. 4 is a diagram illustrating an imaging area of a wide-angle camera forming a vehicle outside imager and a field of view of a driver.

FIG. 5 is a block diagram illustrating an example of a configuration of an information presentation control device of FIG. 1.

FIG. 6 is a diagram illustrating view angles of images displayed on the left display unit and right display unit.

FIG. 7 is a diagram illustrating an example of an obstacle detected in an imaged image and a rectangular region including the obstacle.

FIG. 8 is a table illustrating an example of a method of determination regarding display on the left display unit by an emphasis determiner of the first embodiment.

FIG. 9 is a schematic diagram illustrating a modification of a display device.

FIG. 10 is a block diagram illustrating an information presentation device of a second embodiment of the present invention.

FIG. 11 is a block diagram illustrating an example of a configuration of an information presentation control device of FIG. 10.

FIG. 12 is a block diagram illustrating an example of a configuration of an information presentation control device used in a third embodiment of the present invention.

FIG. 13 is a table illustrating an example of a method of determination regarding display on the left display unit by an emphasis determiner of the third embodiment.

FIG. 14 is a schematic diagram illustrating a vehicle running on a narrow road.

FIG. 15 is a block diagram illustrating an information presentation device of a fourth embodiment of the present invention.

FIG. 16 is a block diagram illustrating an example of a configuration of an information presentation control device of FIG. 15.

FIG. 17 is a block diagram illustrating an information presentation control device used in a fifth embodiment of the present invention.

FIGS. 18A and 18B are diagrams illustrating an example of a method of determining a degree of risk of an obstacle.

FIG. 19 is a table illustrating an example of a method of determination regarding display on the left display unit by an emphasis determiner of the fifth embodiment.

FIG. 20 is a diagram illustrating a modification of an arrangement of cameras of the vehicle outside imager.

FIG. 21 is another diagram illustrating a modification of an arrangement of cameras of the vehicle outside imager.

FIG. 22 is another diagram illustrating a modification of an arrangement of cameras of the vehicle outside imager.

FIG. 23 is a block diagram illustrating an example of a configuration of a computer including one processor that implements functions of the information presentation control devices used in the first to fifth embodiments.

### DETAILED DESCRIPTION OF THE INVENTION

Hereinafter, embodiments of the present invention will be described with reference to the attached drawings.

### First Embodiment

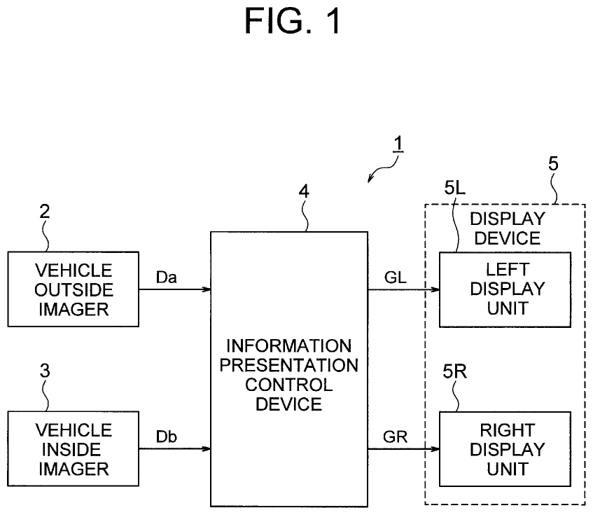

FIG. 1 is a block diagram illustrating an example of a configuration of an information presentation device 1 of a first embodiment of the present invention.

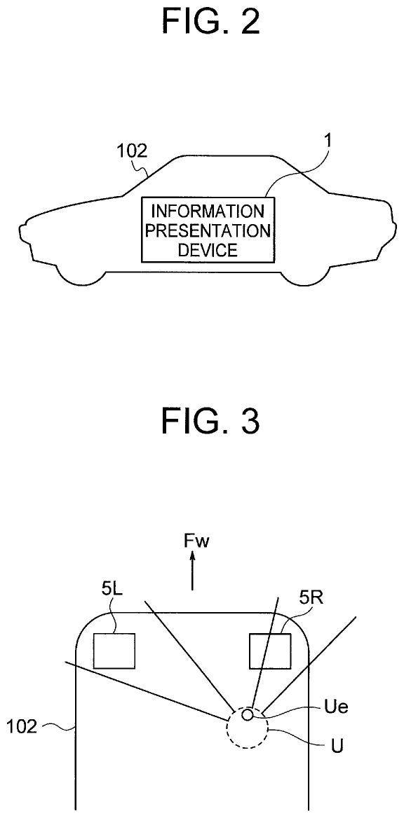

The illustrated information presentation device 1 is mounted on a vehicle 102, for example, as illustrated in FIG. 2, and includes a vehicle outside imager 2, a vehicle inside imager 3, an information presentation control device 4, and a display device 5.

The display device 5 includes a left display unit 5L as a left display means and a right display unit 5R as a right display means. For example, as illustrated in FIG. 3, the left display unit 5L is located to the left, and the right display unit 5R is located to the right, as viewed from a point of view Ue of a driver U sitting in a driver seat on the right side of the vehicle and facing in a forward direction FW.

The vehicle outside imager 2 images an area around the vehicle 102, and generates and outputs a vehicle outside image Da.

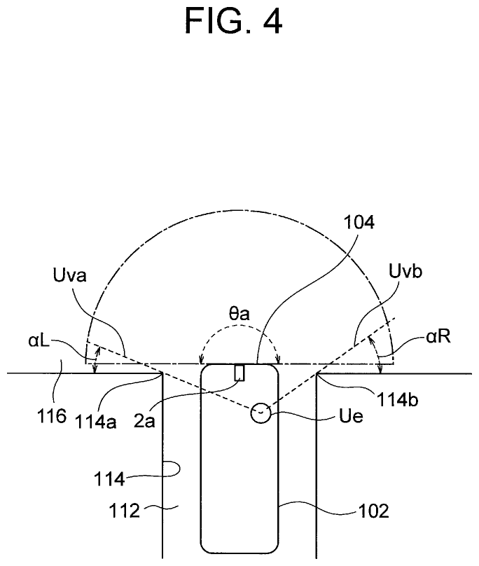

The vehicle outside imager 2 includes a wide-angle camera 2a illustrated in FIG. 4. The wide-angle camera 2a is mounted on the vehicle 102 and images the outside of the vehicle. The wide-angle camera 2a is located at a front end portion 104 of the vehicle 102, for example. In the illustrated example, the wide-angle camera 2a is located at a central portion of the vehicle in a width direction of the vehicle.

A horizontal view angle θa of the wide-angle camera 2a is preferably 180 degrees or more.

In FIG. 4, the vehicle 102 is about to enter an intersection 116 from a narrow road 112 with structures 114 or the like, such as sidewalls, blocking the view on both sides. In this case, for the driver U, areas αL and αR located outside a viewable area defined by a set of straight lines Uva and Uvb connecting the point of view Ue and tips 114a and 114b of the structures 114 are blind or hard-to-see areas. Here, the “hard-to-see areas” are areas that the driver cannot see without greatly changing his/her position or taking other actions. The hard-to-see areas are areas that cannot be seen in a normal position, and thus in this sense can also be referred to as blind or dead areas.

The view angle θa of the camera 2a includes at least part of the above blind or hard-to-see areas αL and αR. Thus, an image imaged by the camera 2a includes obstacles in the blind or hard-to-see areas.

Although the above example is a case of entering an intersection, there is the same problem in a case of entering a road from a parking space in a building.

The vehicle inside imager 3 images an inside of the vehicle, in particular the driver's face and an area therearound, and generates and outputs a vehicle inside image Db.

The vehicle inside imager 3 includes a camera (not illustrated) located so that it can image the driver's face and an area therearound.

The camera may include an infrared sensor so that the imaging is possible even when the inside of the vehicle is dark. It may further include an infrared irradiator together with an infrared sensor.

The information presentation control device 4 controls image display on the display device 5 on the basis of the vehicle outside image Da and vehicle inside image Db.

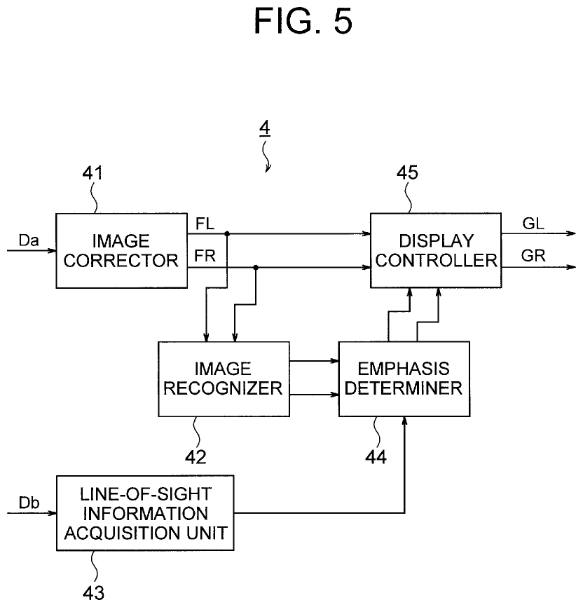

The information presentation control device 4 includes an image corrector 41, an image recognizer 42, a line-of-sight information acquisition unit 43, an emphasis determiner 44, and a display controller 45, as illustrated in FIG. 5, for example.

The image corrector 41 extracts a left image and a right image from the vehicle outside image Da input from the vehicle outside imager 2, performs distortion correction on the extracted images, and outputs them as a left corrected image FL and a right corrected image FR.

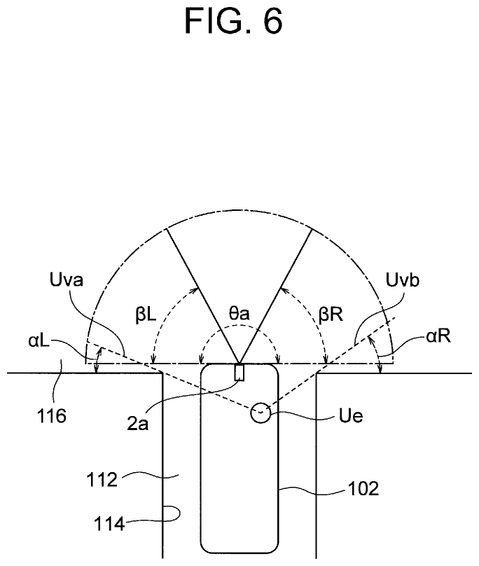

The left image and right image are images having view angles βL and βR in FIG. 6, respectively, for example.

The view angle βL is an angular range with a direction tilted to the left relative to the front direction as its center.

The view angle βR is an angular range with a direction tilted to the right relative to the front direction as its center.

The view angle βL includes at least part of the blind or hard-to-see area αL, and the view angle βR includes at least part of the blind or hard-to-see area αR.

Since the left image and right image are images obtained by imaging with a wide-angle lens, they are distorted, difficult for a human to see, and difficult to perform image recognition processing with the image recognizer 42. Thus, the distortion correction removes the distortion to provide easy-to-see images.

The image recognizer 42 performs image recognition on each of the left corrected image FL and right corrected image FR, recognizes one or more obstacles in the images, and generates and outputs obstacle information indicating a result of the obstacle recognition. Various known algorithms may be used for the image recognition.

The obstacles described here are other vehicles, pedestrians, or the like that need to be avoided in driving. The vehicles include automobiles and bicycles.

The vehicle 102 provided with the information presentation device 1 may be referred to as the “own vehicle” in order to distinguish it from the other vehicles.

The obstacle information includes, for each obstacle, information indicating the type of the obstacle, information indicating the position of the obstacle in the image, and information indicating the size of the obstacle in the image.

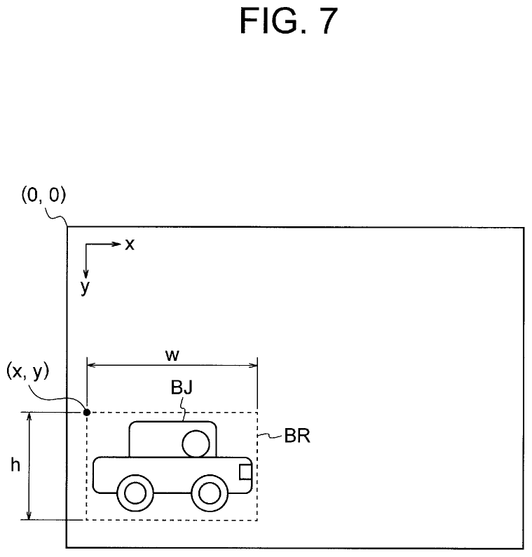

The position of an obstacle in the image is indicated by two-dimensional coordinates (x, y) of the position of a representative point of the obstacle with a reference point, e.g., a left upper corner, of the image as an origin, as illustrated in FIG. 7. The representative point described here is, for example, a left upper corner of a rectangular region including the obstacle.

For each obstacle, the rectangular region including the obstacle is a rectangular region having, as sides, a horizontal line segment passing through a lowermost point of the obstacle in the image, a horizontal line segment passing through an uppermost point of the obstacle in the image, a vertical line segment passing through a leftmost point of the obstacle in the image, and a vertical line segment passing through a rightmost point of the obstacle in the image.

For example, as illustrated in FIG. 7, when an obstacle BJ is recognized in an image, a rectangular region BR including it is detected.

The information indicating the size of the obstacle may be information indicating a width w and a height h of the rectangular region BR. Alternatively, coordinates of a left upper corner and coordinates of a right lower corner of the rectangular region BR may be used as the information indicating the size.

The line-of-sight information acquisition unit 43 performs face detection and facial feature detection on the vehicle inside image Db, detects a direction of a line of sight, and generates and outputs line-of-sight information indicating the direction of the line of sight. Various known methods may be used for the face detection, the facial feature detection, and the line-of-sight direction detection based on results of these detections.

The emphasis determiner 44 makes a determination regarding display on each of the left display unit 5L and right display unit 5R, on the basis of the obstacle information from the image recognizer 42 and the line-of-sight information from the line-of-sight information acquisition unit 43.

The determination regarding the display includes a determination as to whether display is needed, and a determination regarding emphasis processing. The determination regarding the emphasis processing includes a determination as to whether the emphasis processing is needed, and a determination of an emphasis level.

The emphasis processing is processing for highlighting an obstacle in an image. As a method of the emphasis processing, for example, any of the following methods may be used:

(a1) enclosing the obstacle with a line having a prominent color;

(a2) blinking a line enclosing the obstacle;

(a3) brightening a periphery of the obstacle; and

(a4) blurring, erasing, or darkening the image except for the obstacle.

In this embodiment, the emphasis processing is performed at different levels.

As a method of increasing the emphasis level, the following methods may be used:

(b1) when the emphasis is performed by method (a1), changing the color of the enclosing line to a more prominent color (for example, red may be used as a color more prominent than orange);

(b2) when the emphasis is performed by method (a2), decreasing the cycle of blinking of the enclosing line;

(b3) when the emphasis is performed by method (a3), increasing the brightness of the periphery of the obstacle; and

(b4) when the emphasis is performed by method (a4), increasing the degree of blurring, erasing, or darkening of the image.

It is also possible to use one of methods (a1) to (a4) in the emphasis processing at a certain level and use another one in the emphasis processing at another level.

As above, the determination regarding the display made by the emphasis determiner 44 includes, for each display unit, a determination as to whether display on the display unit is needed, and a determination of the emphasis level on the display unit.

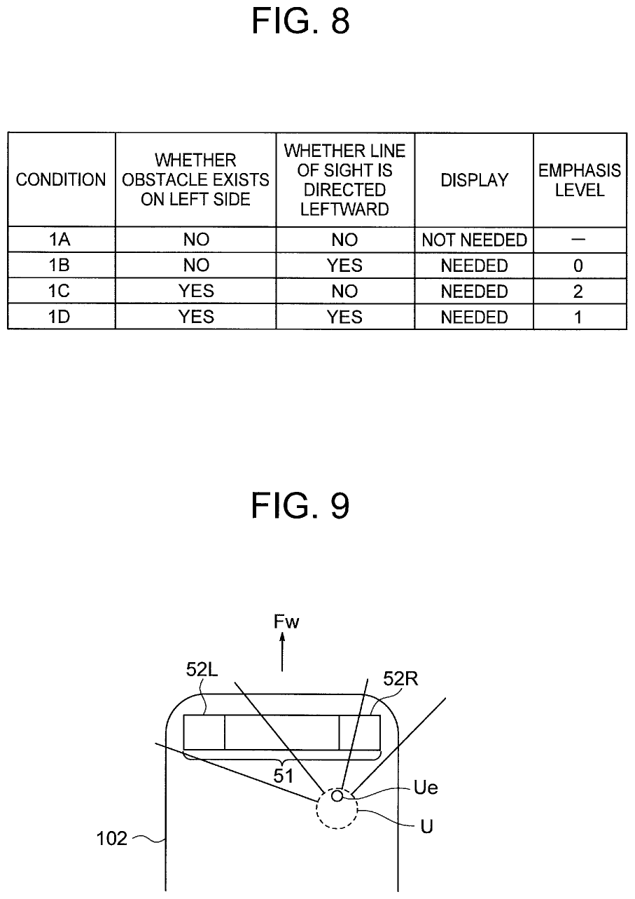

FIG. 8 illustrates an example of a method (determination rule) of the determination regarding the display on the left display unit 5L.

In FIG. 8, conditions 1A to 1D correspond to the combination of the result of a determination as to whether an obstacle is present in the left corrected image FL and the result of a determination as to whether the line of sight is directed to the left, i.e., four cases in total. FIG. 8 shows, for each case, whether display on the left display unit 5L is needed and the emphasis level on the left display unit 5L.

In condition 1A, no obstacle is present on the left side, and the line of sight of the driver is not directed to the left. When condition 1A is satisfied, it is determined that the display is not needed. As a result, in the left display unit 5L, neither the image FL nor an image generated therefrom is displayed, or the brightness of the display is greatly decreased.

In condition 1B, no obstacle is present on the left side, and the line of sight of the driver is directed to the left. When condition 1B is satisfied, it is determined that the display is needed. However, since no obstacle is present, it is determined that the emphasis processing is not needed. The fact that the emphasis processing is not needed is indicated by “emphasis level 0”.

In condition 1C, an obstacle is present on the left side, and the line of sight of the driver is not directed to the left. When condition 1C is satisfied, it is determined that the display is needed. Also, it is determined that the emphasis processing on the obstacle in the image is needed.

In condition 1D, an obstacle is present on the left side, and the line of sight of the driver is directed to the left. When condition 1D is satisfied, it is determined that the display is needed. Also, it is determined that the emphasis processing on the obstacle in the image is needed.

The level of the emphasis is higher in the case of condition 1C than in the case of condition 1D. In the illustrated example, while the emphasis level is 1 in the case of condition 1D, the emphasis level is 2 in the case of condition 1C.

This is because, while the driver is probably aware of the obstacle in the case of condition 1D, the driver is probably not aware in the case of condition 1C.

Increasing the emphasis level makes the obstacle in the image more prominent and makes it possible for the driver to notice the obstacle sooner.

Although the determination regarding the display on the left display unit 5L has been described above, the determination regarding the display on the right display unit 5R can also be made in the same manner. Specifically, when “left” in the above description is replaced with “right”, the description applies to the determination regarding the display on the right display unit 5R.

Regarding the determination method for the left display unit 5L, the expression “the line of sight is directed to the left” is not limited to the case where the line of sight is continuously maintained to be directed to the left, and may allow short-time interruptions. For example, it is allowed that the state where it is directed to the left and the state where it is directed in another direction for only a short time alternate.

Thus, for example, when the state where it is directed to the left and the state where it is directed to the right alternate at short time intervals, it is determined to be “directed to the left” and also “directed to the right”.

In this case, for both the left display unit 5L and right display unit 5R, it is determined that the display is needed.

This is because, from alternation of the direction of the line of sight at short time intervals, it is inferred that the blind or hard-to-see area of the driver is large, and it is difficult for the driver to check whether an obstacle is present, by direct viewing.

The display controller 45 controls display on each of the left display unit 5L and right display unit 5R on the basis of a result of the determination by the emphasis determiner 44. The display control includes control of whether to perform display and control regarding the emphasis processing. The control regarding the emphasis processing includes control of whether to perform the emphasis processing and control of the emphasis level.

When the emphasis determiner 44 determines that display on the left display unit 5L is needed, the display controller 45 causes the left display unit 5L to perform image display. In this case, it generates a left presentation image GL by performing the emphasis processing on the left corrected image FL depending on the emphasis level determined by the emphasis determiner 44, supplies it to the left display unit 5L, and causes the left display unit 5L to display it.

When the emphasis determiner 44 determines that display on the left display unit 5L is not needed, the display controller 45 refrains from image display on the left display unit 5L or greatly decreases the display brightness.

When the emphasis determiner 44 determines that display on the right display unit 5R is needed, the display controller 45 causes the right display unit 5R to perform image display. In this case, it generates a right presentation image GR by performing the emphasis processing on the right corrected image FR depending on the emphasis level determined by the emphasis determiner 44, supplies it to the right display unit 5R, and causes the right display unit 5R to display it.

When the emphasis determiner 44 determines that display on the right display unit 5R is not needed, the display controller 45 refrains from image display on the right display unit 5R or greatly decreases the display brightness.

The images FL, FR, GL, and GR are all images obtained by imaging, and thus may be referred to simply as imaged images.

When the left presentation image GL is displayed on the left display unit 5L, since a left imaged image (e.g., an image having the view angle βL) is displayed, it is possible to see an image of an obstacle located to the left on the left display unit 5L. Specifically, even when an obstacle is located in a direction such that it cannot be seen by the driver or is difficult for the driver to see, or in the area αL, the obstacle can be seen in the displayed image.

Similarly, when the right presentation image GR is displayed on the right display unit 5R, since a right imaged image (e.g., an image having the view angle βR) is displayed, it is possible to see an image of an obstacle located to the right on the right display unit 5R. Specifically, even when an obstacle is located in a direction such that it cannot be seen by the driver or is difficult for the driver to see, or in the area αR, the obstacle can be seen in the displayed image.

The determination regarding the display in the above description is a determination regarding display of imaged images, i.e., images obtained by imaging by the vehicle outside imager 2. When it is determined that the display is not needed, the display is not performed, or the display brightness is greatly decreased.

Here, “the display is not performed” means that no imaged images are displayed, and when no imaged images, i.e., no images obtained by imaging by the vehicle outside imager 2, are displayed, other images may be displayed.

FIG. 3 illustrates a case where the vehicle 102 is a right-hand drive vehicle and the position of the point of view Ue of the driver is on the right side of the vehicle 102. When the vehicle 102 is a left-hand drive vehicle, although the point of view Ue of the driver is on the left side of the vehicle 102, the same control as described above can be performed.

In the above example, the display device 5 includes the left display unit 5L and right display unit 5R.

Alternatively, as the display device, it is possible to use one that includes a single horizontally long display surface 51 as illustrated in FIG. 9 and is capable of displaying different images on a left display region 52L and a right display region 52R in the display surface 51.

In this case, the left display region 52L forms the left display means, and the right display region 52R forms the right display means.

In the above example, the image corrector 41 extracts the left image and right image from the vehicle outside image Da input from the vehicle outside imager 2, performs distortion correction on the extracted images, and outputs them as the left corrected image FL and right corrected image FR.

Depending on the type of the camera 2a, the camera 2a may extract a left image and a right image and output images after distortion correction. In this case, the extraction processing and distortion correction processing by the image corrector 41 can be omitted. Thus, the image corrector 41 may be omitted.

In the above example, the display device includes the left display means and right display means. However, the display device 5 may include three or more display means.

With the above first embodiment, for each obstacle, an image including the obstacle is displayed on a display means located in a direction of the obstacle or a direction close thereto. This makes it possible for the driver to see images of the obstacles in a natural manner. Specifically, when the driver is seeing an area around the vehicle 102 in a certain direction, the driver need not shift the line of sight in order to see an image obtained by imaging in the same direction. Thus, the time taken to see the image can be reduced.

Also, since an obstacle in an image displayed on a display means is located in the same direction as the display means, the driver can intuitively perceive the direction in which the obstacle is located.

Also, for each display means, whether image display on the display means is needed is determined depending on the direction of the line of sight of the driver. Thus, it is possible to perform obstacle display to perform alerting when it is needed, and refrain from performing the display or decrease the display brightness when it is not needed, thereby avoiding unnecessary alerting.

Further, emphasis on an obstacle in an image displayed on a display means is controlled depending on the direction of the line of sight of the driver. Thus, it is possible to appropriately change the level of the emphasis depending on the degree of necessity. For example, when the line of sight of the driver is directed in a direction different from that of an obstacle, by performing the emphasis display, it is possible to attract attention to the obstacle and facilitate perception of the obstacle. On the other hand, when the line of sight of the driver is directed toward an obstacle, by refraining from the emphasis display or decreasing the level of the emphasis, it is possible to prevent the image from excessively standing out.

### Second Embodiment

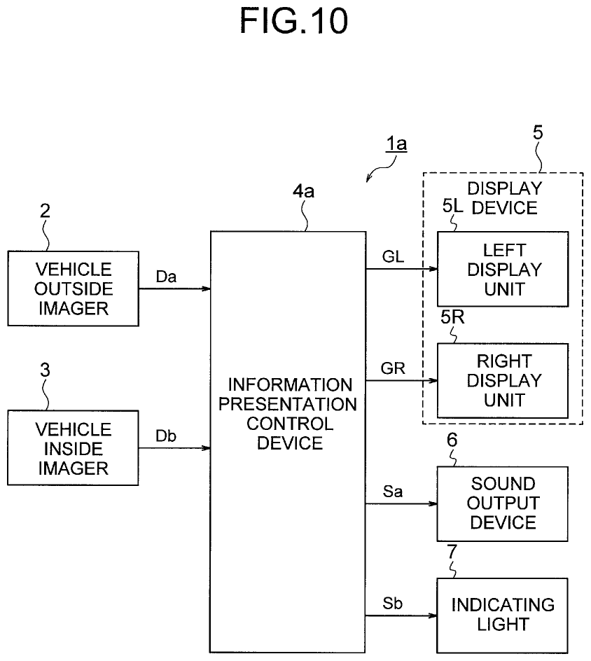

FIG. 10 is a block diagram illustrating an example of a configuration of an information presentation device la of a second embodiment of the present invention.

While the illustrated information presentation device 1a is generally the same as the information presentation device 1 of FIG. 1, it additionally includes a sound output device 6 and an indicating light 7, and includes an information presentation control device 4a instead of the information presentation control device 4.

The sound output device 6 includes one or more speakers.

The indicating light 7 is formed by, for example, one or more indicating elements. Each indicating element may be formed by an LED.

The indicating light 7 may be provided, for example, on a dashboard or on an A-pillar (front pillar).

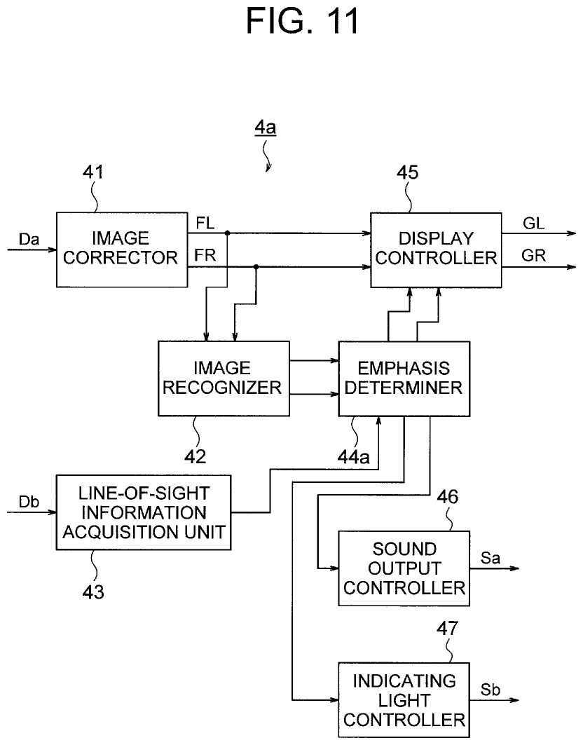

FIG. 11 illustrates the information presentation control device 4a of FIG. 10. While the illustrated information presentation control device 4a is generally the same as the information presentation control device 4 of FIG. 5, it additionally includes a sound output controller 46 and an indicating light controller 47, and includes an emphasis determiner 44a instead of the emphasis determiner 44.

The emphasis determiner 44a makes a determination regarding the display in the same manner as the emphasis determiner 44 of the first embodiment, and makes a determination regarding sound output and indicating light control according to the determination regarding the display.

For example, when it is determined that for image display on at least one of the left display unit 5L and right display unit 5R, the display is needed, the emphasis is needed, and the emphasis level should be set to be not less than a predetermined value, it is determined that sound output and alerting by the indicating light are needed.

The above predetermined value for the emphasis level may be the highest of the levels used in the determination regarding the display. For example, in the example illustrated in FIG. 8, emphasis level 2 is the highest.

In a case where emphasis level 2 is used as the above predetermined value, when condition 1C of FIG. 8 is satisfied for the left display unit 5L or when a similar condition is satisfied for the right display unit 5R, it is determined that alerting is needed.

The sound output controller 46 causes the sound output device 6 to output a sound for alerting in accordance with the determination by the emphasis determiner 44a. Specifically, it supplies a sound control signal Sa to the sound output device 6 and causes the sound output device 6 to output the sound.

The sound may be an alert sound or a voice message.

For example, when condition 1C of FIG. 8 is satisfied for the left display unit 5L or when a condition similar to condition 1C of FIG. 8 is satisfied for the right display unit 5R, the sound may be output.

When condition 1C of FIG. 8 is satisfied for the left display unit 5L, a message “please pay attention to the vehicle on the left side” may be output. When a condition similar to condition 1C of FIG. 8 is satisfied for the right display unit 5R, a message “please pay attention to the vehicle on the right side” may be output.

The indicating light controller 47 causes the indicating light 7 to emit light or blink for alerting, in accordance with the determination by the emphasis determiner 44a. Specifically, it supplies an indicating light drive signal Sb to the indicating light 7 and causes the indicating light 7 to emit light or blink.

It is possible to use, as the sound output device 6, a sound output device including multiple speakers, and perform control to make the sound heard from the direction of the obstacle. Such control can be implemented by, for example, sound image control.

Also, it is possible to form the indicating light 7 by using a row of multiple indicating elements arranged linearly, and blink them in order from one end to the other end of the row, thereby indicating the direction in which attention should be directed. For example, it is possible to set the multiple indicating elements in the form of a horizontally extending row, blink them in order from the right end to the left end when the line of sight of the driver is to be guided to the left, and blink them in order from the left end to the right end when the line of sight of the driver is to be guided to the right.

### Third Embodiment

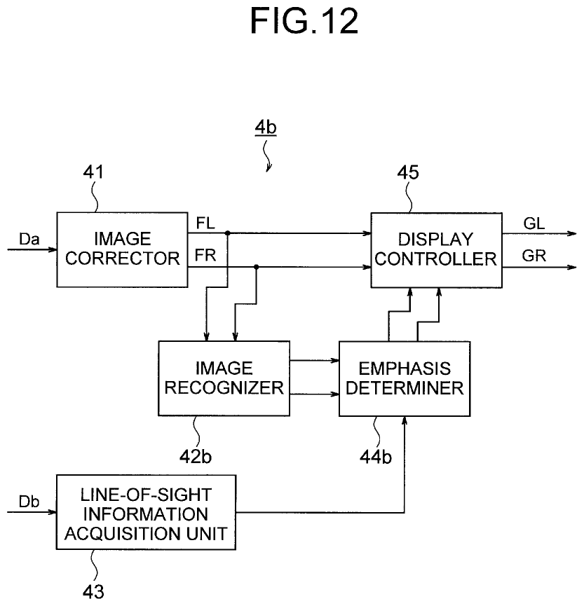

A general configuration of an information presentation device of a third embodiment of the present invention is the same as described for the first embodiment with reference to FIG. 1. FIG. 12 is a block diagram illustrating an example of a configuration of an information presentation control device 4b used in the information presentation device of the third embodiment.

While the illustrated information presentation control device 4b is generally the same as the information presentation control device 4 of FIG. 5, it is provided with an image recognizer 42b and an emphasis determiner 44b instead of the image recognizer 42 and emphasis determiner 44 of FIG. 5.

The image recognizer 42b not only performs recognition of obstacles in the same manner as the image recognizer 42 of FIG. 5, but also performs recognition of a surrounding situation of the own vehicle and generates and outputs surrounding situation information indicating a result of the recognition. The recognition of the surrounding situation of the own vehicle includes, for example, a result of determination as to whether the own vehicle is located near an intersection.

Various known algorithms may be used for the recognition of the surrounding situation of the own vehicle.

Whether the own vehicle is located near an intersection may be determined on the basis of traffic lights, road signs, road markings, or the like in an image.

The emphasis determiner 44b makes the determination regarding the display by using not only the obstacle information and line-of-sight information but also the surrounding situation information.

For example, when it is determined that the own vehicle is not located near an intersection, it is determined that the display of the imaged images is not needed.

When it is determined that the own vehicle is located near an intersection, the determination regarding the display is made on the basis of the obstacle information and line-of-sight information in the same manner as FIG. 8.

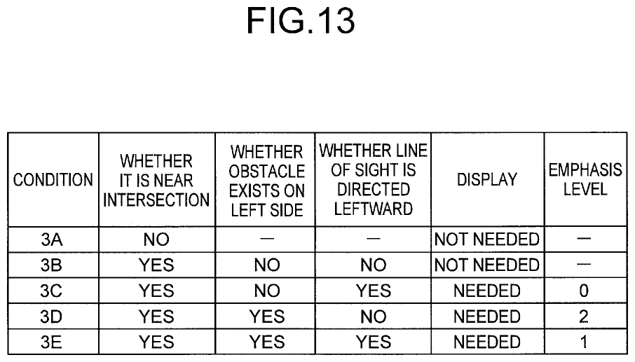

FIG. 13 illustrates an example of a method (determination rule) of the determination regarding the display on the left display unit 5L in the third embodiment.

In condition 3A, the own vehicle is not located near an intersection. When condition 3A is satisfied, it is determined that the display is not needed. That is, when the own vehicle is not located near an intersection, it is determined that the display on the left display unit 5L is not needed, regardless of the presence or absence of obstacles and the direction of the line of sight.

Conditions 3B to 3E are cases where the own vehicle is located near an intersection.

Conditions 3B to 3E are the same as conditions 1A to 1D of FIG. 8, except that they additionally include a condition that the own vehicle is located near an intersection, and the determinations (whether the display is needed, and the emphasis level) regarding the display on the left display unit 5L are the same as in the cases of conditions 1A to 1D.

In the above example, when the own vehicle is located near an intersection, the emphasis determiner 44b makes the determination based on the other conditions in the same manner as the emphasis determiner 44 of the first embodiment, and when the own vehicle is not located near an intersection, the emphasis determiner 44b determines that the display on the left display unit 5L is not needed.

Thus, when the own vehicle is located near an intersection, an alerting level is made high and the determination regarding the display on the left display unit 5L is made as in the first embodiment, whereas when the own vehicle is not located near an intersection, the alerting level is made low and it is determined that the display on the display unit is not needed.

Although the determination regarding the display on the left display unit 5L has been described above, the determination regarding the display on the right display unit 5R can also be made in the same manner. Specifically, when “left” in the above description is replaced with “right”, the description applies to the determination regarding the display on the right display unit 5R.

Although the above example determines whether it is near an intersection, it is conceivable that even at an intersection, when it is an intersection with good visibility, there is no need to make the alerting level high. Thus, it is also possible to determine whether it is about to enter an intersection from a narrow road with poor visibility, and make the determination regarding the display by taking into account the result of the determination.

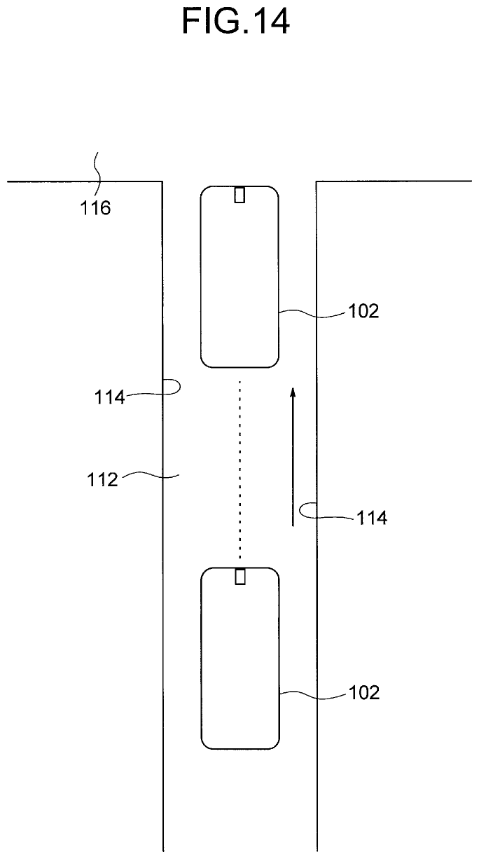

For example, it is possible to determine whether the own vehicle has been running on a narrow road 112 with structures 114, such as sidewalls, on both sides for a predetermined time or more, as illustrated in FIG. 14, and use the result of the determination. Specifically, when the result of such determination is YES and it is detected that the own vehicle is located near an intersection 116, the alerting level may be raised.

Alternatively, it is possible to measure a distance to a structure 114, such as a sidewall, located on a side of the own vehicle by using a distance sensor, and use the result of the measurement. Specifically, when the distance to the structure 114 is small and it is detected that the own vehicle is located near an intersection 116, the alerting level may be raised.

The above has described examples where the alerting level is made high when the own vehicle is located near an intersection. However, alternatively, it is possible to determine whether the own vehicle is about to enter a road from a parking space in a building, and make the alerting level high when it is in such a state.

In these cases, when the alerting level is made high, the determination regarding the display according to conditions 3B to 3E of FIG. 13 is made.

The above third embodiment provides the following advantage in addition to the same advantages as the first embodiment.

Since the determination regarding the display and the control of the display are made on the basis of the surrounding situation information generated by the image recognizer 42b, it is possible to appropriately make the determination as to whether the display is needed, the determination of the emphasis level, and the like depending on the surrounding situation of the own vehicle.

### Fourth Embodiment

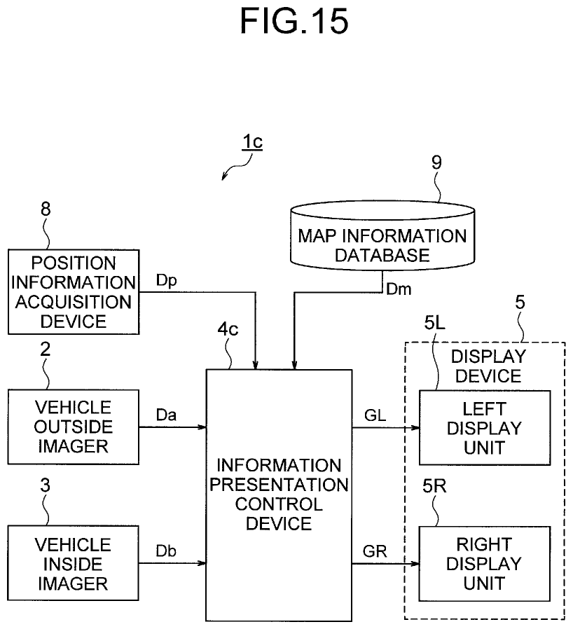

FIG. 15 is a block diagram illustrating an example of a configuration of an information presentation device 1c of a fourth embodiment of the present invention.

While the illustrated information presentation device 1c is generally the same as the information presentation device 1 of FIG. 1, it additionally includes a position information acquisition device 8 and a map information database 9, and is provided with an information presentation control device 4c instead of the information presentation control device 4.

The position information acquisition device 8 generates and outputs position information Dp indicating the position of the own vehicle. A typical example is a global positioning system (GPS) receiver, but any position information acquisition device may be used.

The map information database 9 is a database that stores map information. The map information includes information regarding intersections.

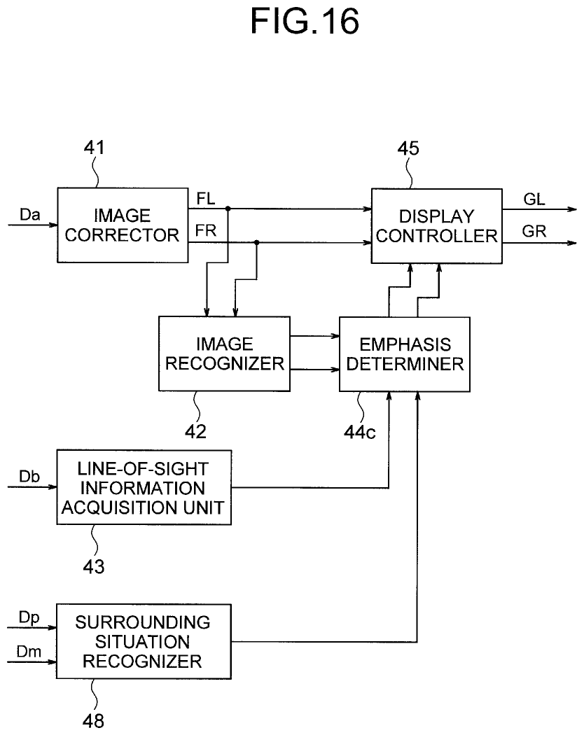

FIG. 16 is a block diagram illustrating an example of a configuration of the information presentation control device 4c.

While the illustrated information presentation control device 4c is generally the same as the information presentation control device 4b of FIG. 12, it additionally includes a surrounding situation recognizer 48, and includes an emphasis determiner 44c instead of the emphasis determiner 44b.

The surrounding situation recognizer 48 acquires the position information Dp of the own vehicle from the position information acquisition device 8, acquires map information Dm around the own vehicle from the map information database 9, recognizes a surrounding situation of the own vehicle by referring to map information around the position indicated by the position information, and generates and outputs surrounding situation information indicating a result of the recognition. The surrounding situation information indicates, for example, whether the own vehicle is located near an intersection.

The emphasis determiner 44c of FIG. 16 makes the determination regarding the display on the basis of the obstacle information, line-of-sight information, and surrounding situation information in the same manner as the emphasis determiner 44b of FIG. 12. However, while the surrounding situation information is supplied from the image recognizer 42b in FIG. 12, it is supplied from the surrounding situation recognizer 48 in FIG. 16.

The method of the determination regarding the display based on the obstacle information, line-of-sight information, and surrounding situation information is the same as described for the third embodiment with reference to FIG. 13.

Although the determination regarding the display on the left display unit 5L has been described above, the determination regarding the display on the right display unit 5R can also be made in the same manner. Specifically, when “left” in the above description is replaced with “right”, the description applies to the determination regarding the display on the right display unit 5R.

When the map information includes information indicating the widths of roads, such information may be further used. For example, it is possible that only when it enters an intersection from a narrow road, the alerting level is made high and the determination regarding the display on the display units is made as in the first embodiment; otherwise, i.e., when the own vehicle is not located near an intersection or when it is located near an intersection but is running on a wide road, the alerting level is made low and it is determined that the display on the display units is not needed.

Also, as the surrounding situation information, instead of the result of determination as to whether the own vehicle is located near an intersection, it is possible to determine whether the own vehicle is about to enter a road from a parking space in a building, and make the alerting level high when it is in such a state.

The above fourth embodiment provides the same advantages as the third embodiment.

Also, since the surrounding situation information is generated from the position information and map information, even when recognition based on an imaged image is difficult, it is possible to properly recognize the surrounding situation.

In the third embodiment, a result of recognition by the image recognizer 42b is used in determination as to whether the own vehicle is located near an intersection, and in the fourth embodiment, map information from the map information database 9 is used in determination as to whether the own vehicle is located near an intersection. However, instead of or together with them, on the basis of at least one of the speed of the own vehicle and operation of direction indicators by the driver, whether the own vehicle is located near an intersection may be determined.

### Fifth Embodiment

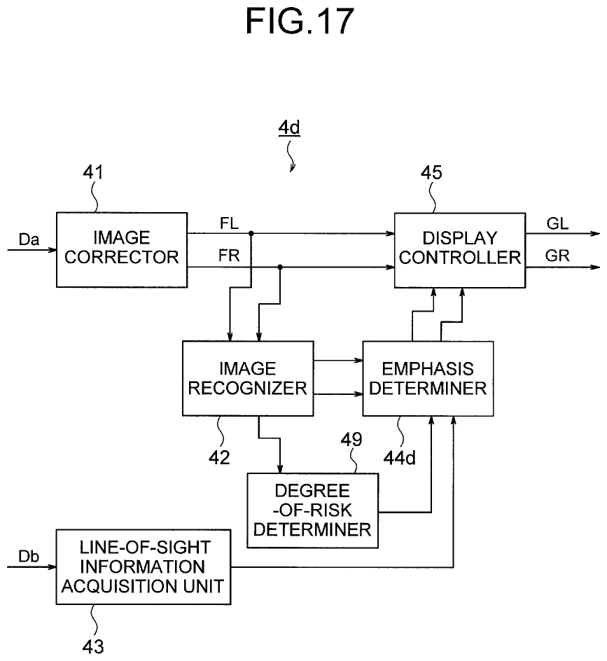

A general configuration of an information presentation device of a fifth embodiment of the present invention is the same as described for the first embodiment with reference to FIG. 1. FIG. 17 is a block diagram illustrating an example of a configuration of an information presentation control device 4d used in the information presentation device of the fifth embodiment.

While the illustrated information presentation control device 4d is generally the same as the information presentation control device 4 of FIG. 5, it additionally includes a degree-of-risk determiner 49, and is provided with an emphasis determiner 44d instead of the emphasis determiner 44 of FIG. 5.

The degree-of-risk determiner 49 determines, on the basis of the obstacle information from the image recognizer 42, degrees of risk of the obstacles, and generates and outputs degree-of-risk information indicating a result of the determination.

For example, on the basis of the position of an obstacle in the image, the degree of risk may be determined.

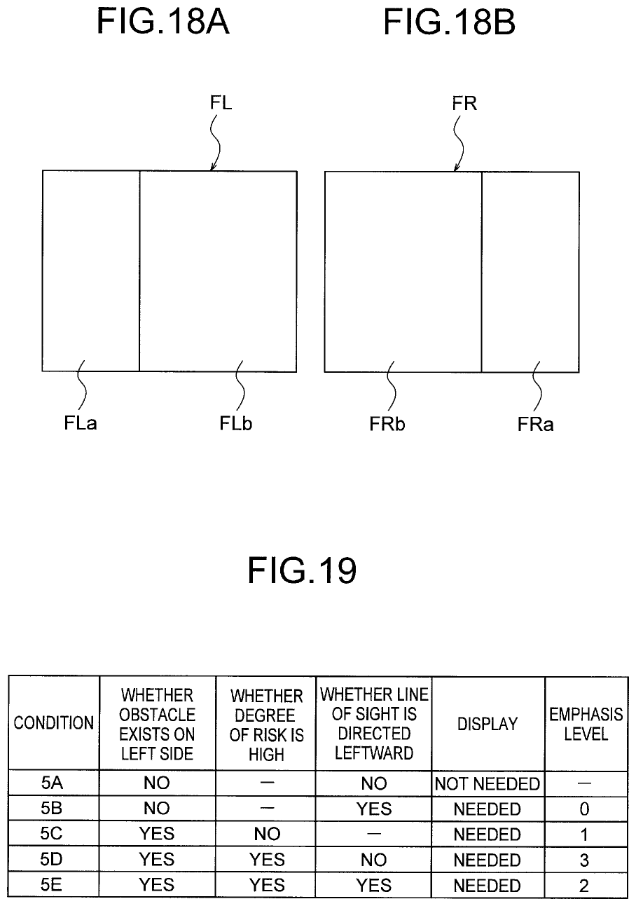

For example, for the left corrected image FL, as illustrated in FIG. 18A, a portion FLa of the image near the left end is specified as a region where the degree of risk is relatively high, and the remaining portion FLb is specified as a region where the degree of risk is relatively low. Then, for an obstacle located in the region FLa, the degree of risk is determined to be high. A reason why the determination is made in this manner is because an obstacle located in the region FLa is located closer to the own vehicle.

Similarly, for the right corrected image FR, as illustrated in FIG. 18B, a portion FRa of the image near the right end is specified as a region where the degree of risk is relatively high, and the remaining portion FRb is specified as a region where the degree of risk is relatively low. Then, for an obstacle located in the region FRa, the degree of risk is determined to be high. A reason why the determination is made in this manner is because an obstacle located in the region FRa is located closer to the own vehicle.

Since the moving speed depends on the type of the obstacle, the positions or sizes of the regions FLa and FRa may be changed. For example, it is possible to determine the type of the obstacle, and perform the above change depending on a result of the determination.

The emphasis determiner 44d makes the determination regarding the display by using the above degree-of-risk information in addition to the obstacle information and line-of-sight information described in the description of the emphasis determiner 44 of the first embodiment.

When there are multiple obstacles in an image, the determination regarding the display may be made on the basis of the degree of risk of the obstacle having the highest degree of risk.

FIG. 19 illustrates an example of a method (determination rule) of the determination regarding the display on the left display unit 5L in the fifth embodiment.

In condition 5A, no obstacle is present on the left side, and the line of sight of the driver is not directed to the left. When condition 5A is satisfied, it is determined that the display is not needed.

In condition 5B, no obstacle is present on the left side, and the line of sight of the driver is directed to the left. When condition 5B is satisfied, it is determined that the display is needed. However, since no obstacle is present, it is determined that the emphasis processing is not needed. The fact that the emphasis processing is not needed is indicated by “emphasis level 0”.

In condition 5C, an obstacle is present on the left side, and the degree of risk thereof is low. When condition 5C is satisfied, it is determined that the display is needed, and the emphasis level is set to 1, regardless of the direction of the line of sight.

In condition 5D, an obstacle is present on the left side, the degree of risk thereof is high, and the line of sight of the driver is not directed to the left. When condition 5D is satisfied, it is determined that the display is needed, and the emphasis level is set to 3.

In condition 5E, an obstacle is present on the left side, the degree of risk thereof is high, and the line of sight of the driver is directed to the left. When condition 5E is satisfied, it is determined that the display is needed, and the emphasis level is set to 2.

As can be seen from comparison between the cases of conditions 5C, 5D, and 5E, in cases where it is determined that the display is needed, the emphasis level varies depending on the degree of risk. Specifically, the higher the degree of risk, the higher the emphasis level is made. This makes it possible to make the driver perceive an obstacle sooner as the degree of risk of the obstacle is higher.

As can be seen from comparison between the cases of conditions 5D and 5E, in cases where an obstacle having a high degree of risk is present on the left side, the emphasis level varies depending on the direction of the line of sight of the driver. For example, when the direction of the line of sight of the driver is not left, the emphasis level is set to be higher.

This is because, when the direction of the line of sight is not left, the driver is probably not aware of the obstacle on the left side, and it is desirable to increase the emphasis level, thereby making the driver perceive the obstacle on the left side sooner.

Emphasis levels 0 to 3 described here are obtained by increasing the number of levels relative to emphasis levels 0 to 2 described in the first and third embodiments.

Although the determination regarding the display on the left display unit 5L has been described above, the determination regarding the display on the right display unit 5R can also be made in the same manner. Specifically, when “left” in the above description is replaced with “right”, the description applies to the determination regarding the display on the right display unit 5R.

In the above example, the degree of risk is determined on the basis of the position of the obstacle in the image. Thus, the degree of risk can be determined by relatively simple processing.

In the above example, whether the degree of risk is relatively high is determined. It is also possible to divide the degree of risk into three or more levels according to the level thereof and make the determination regarding the display depending on which of the levels it is at.

The degree of risk may be determined by a method other than the above method. For example, the degree of risk may be determined on the basis of a relative speed between the own vehicle and the obstacle.

For example, the degree of risk may be determined by using a result obtained by another sensor.

Also, it is possible to determine whether the own vehicle is located near an intersection, as in the third and fourth embodiments, and determine the degree of risk on the basis of the result of the determination. For example, when it is located near an intersection, the degree of risk may be determined to be higher.

The above fifth embodiment provides the following advantage in addition to the same advantages as the first embodiment.

Since the determination regarding the display is made on the basis of the degree-of-risk information, it is possible to appropriately perform display control depending on the degree of risk.

For example, when the degree of risk of a recognized obstacle is high, it is possible to perform the display while performing the emphasis at an emphasis level corresponding to the degree of risk. On the other hand, when the degree of risk is low, it is possible to refrain from the display, greatly decrease the display brightness, or perform the display at a low emphasis level. Thus, it is possible to, while performing the display and emphasis as needed, avoid excessive alerting when it is not needed.

In the first to fifth embodiments, as a camera of the vehicle outside imager, the wide-angle camera 2a is located at the front end portion of the vehicle 102 and at the central portion in the width direction.

This is not mandatory, and it is sufficient that blind or hard-to-see areas of the driver can be imaged as illustrated in FIG. 6. Specifically, the location or number of camera(s) included in the vehicle outside imager are not limited.

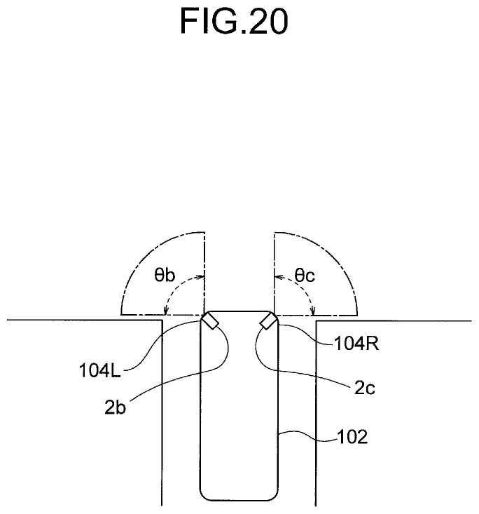

For example, as illustrated in FIG. 20, cameras 2b and 2c that are not wide-angle may be located at a portion 104L of the left side and a portion 104R of the right side of a front end portion of the vehicle 102, respectively. In the example illustrated in FIG. 20, the camera 2b images an area within a view angle θb with a leftward and forward direction as its center, and the camera 2c images an area within a view angle θc with a rightward and forward direction as its center. The view angles θb and θc are, for example, 90 degrees.

In the case of using cameras that are not wide-angle, there is no need to perform the distortion correction in the image corrector 41. Also, when respective imaged images are acquired from two cameras, there is no need to perform the extraction of left and right images in the image corrector 41.

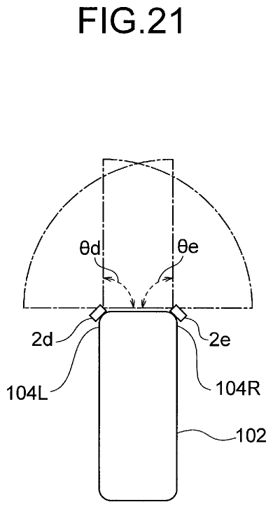

Also, as illustrated in FIG. 21, it is possible that an area within a view angle θd with a rightward and forward direction as its center is imaged by a first camera 2d located at a portion 104L of the left side of a front end portion of the vehicle 102, and an area within a view angle θe with a leftward and forward direction as its center is imaged by a second camera 2e located at a portion 104R of the right side of the front end portion of the vehicle 102, so that the imaging area of each camera includes part of the vehicle 102.

Specifically, it is possible that the vehicle outside imager 2 includes the first camera 2d located at the portion 104L of the left side of the front end portion of the vehicle 102 and the second camera 2e located at the portion 104R of the right side of the front end portion of the vehicle 102, the view angle θd of the first camera 2d includes an area from a forward direction to a rightward direction of the vehicle 102, the view angle θe of the second camera 2e includes an area from a forward direction to a leftward direction of the vehicle 102, the imaging area of the first camera 2d includes part, e.g., at least part of a right side portion of a front end portion, of the vehicle 102, and the imaging area of the second camera 2e includes part, e.g., at least part of a left side portion of the front end portion, of the vehicle 102.

When the imaging area of each of the cameras 2d and 2e includes part of the vehicle 102 as described above, there is the advantage that it is easy for the driver to understand the imaging areas and associate positions in the imaged images with positions in the real space.

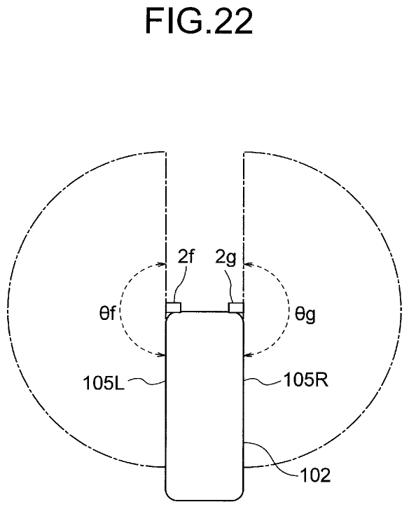

Further, as illustrated in FIG. 22, it is possible that wide-angle cameras 2f and 2g are located at a portion 105L of the left side and a portion 105R of the right side of the vehicle 102 so that each camera can image not only an area in front of the vehicle 102 but also an area behind the vehicle 102. In the illustrated example, the cameras 2f and 2g are located at a front end portion of a portion of the left side and a front end portion of a portion of the right side of a front end portion of the vehicle. However, they may be located anywhere on the left and right sides, and may be located in the rear. When they are located in the rear, they are effective in backing.

Thus, it is possible that the vehicle outside imager 2 includes the first wide-angle camera 2f located at the portion 105L of the left side of the vehicle 102 and the second wide-angle camera 2g located at the portion 105R of the right side of the vehicle 102, the first wide-angle camera 2f images an area within a view angle θf with a leftward direction as its center, the second wide-angle camera 2g images an area within a view angle θg with a rightward direction as its center, the view angles θf and θg are both 180 degrees or more, the imaging area of the first wide-angle camera 2f includes areas to the left of, in front of, and behind the vehicle 102, and the imaging area of the second wide-angle camera 2g includes areas to the right of, in front of, and behind the vehicle 102.

Such a configuration provides imaged images of wide areas to the left and right of the vehicle 102, and thus allows alerting for obstacles in wide areas.

The modifications described for the first embodiment can be applied to the second to fifth embodiments.

Also, although the second embodiment has been described as a modification to the first embodiment, the same modification can be made to the third to fifth embodiments.

Each of the above information presentation control devices 4, 4a, 4b, 4c, and 4d is formed by one or more processing circuits.

Each processing circuit may be formed by dedicated hardware or may be formed by a processor and a program memory.

When being formed by dedicated hardware, each processing circuit may be, for example, an application specific integrated circuit (ASIC), a field-programmable gate array (FPGA), or a combination of them.

When being formed by a processor and a program memory, each processing circuit may be implemented by software, firmware, or a combination of software and firmware. The software or firmware is described as a program, and stored in the program memory. The processor implements the function of the processing circuit by reading and executing the program stored in the program memory.

Here, the processor may be, for example, what is called a central processing unit (CPU), an arithmetic device, a microprocessor, a microcomputer, or a digital signal processor (DSP).

The program memory may be, for example, a non-volatile or volatile semiconductor memory, such as a random access memory (RAM), a read only memory (ROM), a flash memory, an erasable programmable ROM (EPROM), or an electrically EPROM (EEPROM), a magnetic disc, such as a hard disc, or an optical disc, such as a compact disc (CD) or a digital versatile disc (DVD).

It is possible that a part of the functions of the information presentation control devices 4, 4a, 4b, 4c, and 4d is implemented by dedicated hardware, and another part is implemented by software or firmware. Thus, the information presentation control device 4, 4a, 4b, 4c, or 4d may implement the above functions by using hardware, software, firmware, or a combination of them.

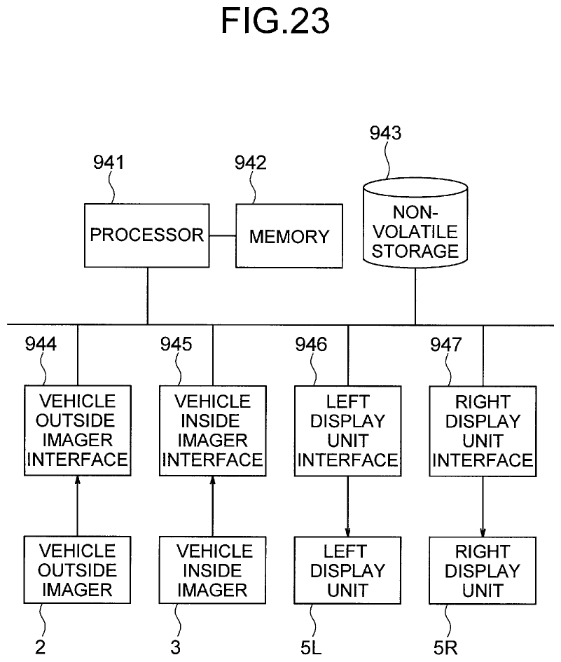

FIG. 23 illustrates a computer including one processor that implements the functions of the information presentation control device 4, 4a, 4b, 4c, or 4d.

The illustrated computer includes a processor 941, a memory 942, a non-volatile storage 943, a vehicle outside imager interface 944, a vehicle inside imager interface 945, a left display unit interface 946, and a right display unit interface 947.

The non-volatile storage 943 stores a program that is executed by the processor 941.

The processor 941 reads the program stored in the non-volatile storage 943, stores it in the memory 942, and executes it.

The vehicle outside imager interface 944 is an interface between the information presentation control device 4, 4a, 4b, 4c, or 4d and the vehicle outside imager 2, and relays image information output from the vehicle outside imager 2 to the information presentation control device 4, 4a, 4b, 4c, or 4d.

The vehicle inside imager interface 945 is an interface between the information presentation control device 4, 4a, 4b, 4c, or 4d and the vehicle inside imager 3, and relays image information output from the vehicle inside imager 3 to the information presentation control device 4, 4a, 4b, 4c, or 4d.

The left display unit interface 946 and right display unit interface 947 are interfaces between the information presentation control device 4, 4a, 4b, 4c, or 4d and the left display unit 5L and right display unit 5R, and respectively relay images output from the information presentation control device 4, 4a, 4b, 4c, or 4d to the left display unit 5L and right display unit 5R.

The vehicle outside imager 2, vehicle inside imager 3, left display unit 5L, and right display unit 5R of FIG. 23 may be the same as those illustrated in FIG. 1.

The non-volatile storage 943 also stores information used in processing in the information presentation control device 4, 4a, 4b, 4c, or 4d. For example, the non-volatile storage 943 stores parameter information used for the image correction in the image corrector 41, the image recognition in the image recognizer 42 or 42b, the emphasis determination in the emphasis determiner 44, 44a, 44b, or 44d, and the like.

The non-volatile storage 943 may be a storage provided separately from the information presentation control device 4, 4a, 4b, 4c, or 4d. For example, a storage located on a cloud may be used as the non-volatile storage 943.

The non-volatile storage 943 may also serve as the map information database 9 of the fourth embodiment, or another storage or storage medium may be provided as the map information database.

Although the information presentation control devices according to the present invention have been described above, the information presentation control methods implemented by the information presentation control devices are also part of the present invention. In addition, programs for causing computers to execute processes of these devices or methods and computer-readable recording media storing such programs are also part of the present invention.

### DESCRIPTION OF REFERENCE CHARACTERS

2 vehicle outside imager, 2a to 2g camera, 3 vehicle inside imager, 4, 4a, 4b, 4c, 4d information presentation control device, 5L left display unit, 5R right display unit, 6 sound output device, 7 indicating light, 8 position information acquisition device, 9 map information database, 41 image corrector, 42, 42b image recognizer, 43 line-of-sight information acquisition unit, 44, 44a, 44b, 44d emphasis determiner, 45 display controller, 46 sound output controller, 47 indicating light controller, 48 surrounding situation recognizer, 49 degree-of-risk determiner, 941 processor, 942 memory, 943 non-volatile storage, 944 vehicle outside imager interface, 945 vehicle inside imager interface, 946 left display unit interface, 947 right display unit interface.

What is claimed is:

1. An information presentation device comprising:
a vehicle outside imager to image an area around a vehicle and generate a vehicle outside image;
a vehicle inside imager to image an inside of the vehicle and generate a vehicle inside image;
a display including a plurality of display portions; and
information presentation controlling circuitry to recognize one or more obstacles from the vehicle outside image, generate obstacle information indicating a result of the recognition of the obstacles, generate, from the vehicle inside image, line-of-sight information indicating a direction of a line of sight of a driver, make a determination regarding display on each of the plurality of display portions, on a basis of the obstacle information and the line-of-sight information, and control display on each of the plurality of display portions, on a basis of the determination,
wherein the determination regarding the display includes, for each of the plurality of display portions, a determination as to whether display of the vehicle outside image on the display portion is needed, and a determination regarding emphasis processing to each obstacle in the vehicle outside image on the display portion,
wherein the determination regarding the emphasis processing includes a determination as to whether emphasis is needed, and a determination of a level of emphasis, and
wherein the information presentation controlling circuitry causes, for each of the recognized one or more obstacles, an image including the obstacle to be displayed on one of the plurality of display portions that is located in a direction of the obstacle or a direction close thereto as viewed from the driver.

2. The information presentation device of claim 1, wherein for each of the plurality of display portions, when the information presentation controlling circuitry determines, in the determination regarding the display, that display on the display portion is not needed, the information presentation controlling circuitry refrains from display of the image including the obstacle on the display portion or decreases a brightness of display of the image including the obstacle on the display portion.

3. The information presentation device of claim 1, wherein
the information presentation controlling circuitry recognizes a surrounding situation of the vehicle and generates surrounding situation information, and
the determination regarding the display is made on a basis of not only the obstacle information and the line-of-sight information but also the surrounding situation information.

4. The information presentation device of claim 3, wherein the information presentation controlling circuitry recognizes the surrounding situation from the vehicle outside image.

5. The information presentation device of claim 3, further comprising a map information database storing map information,
wherein the information presentation controlling circuitry acquires position information indicating a position of the vehicle, and recognizes the surrounding situation by referring to the map information around the position indicated by the position information.

6. The information presentation device of claim 1, wherein
the information presentation controlling circuitry detects a degree of risk for each of the obstacles in the vehicle outside image and generates degree-of-risk information, and
the determination regarding the display is made on a basis of not only the obstacle information and the line-of-sight information but also the degree-of-risk information.

7. The information presentation device of claim 1, wherein the vehicle outside imager includes a wide-angle camera located at a front end portion of the vehicle.

8. The information presentation device of claim 1, wherein
the vehicle outside imager includes:
a first camera located at a portion of a left side of a front end portion of the vehicle; and
a second camera located at a portion of a right side of the front end portion of the vehicle,
the first camera images an area from a forward direction to a rightward direction of the vehicle,
the second camera images an area from the forward direction to a leftward direction of the vehicle,
an imaging area of the first camera includes at least part of a right side portion of the front end portion of the vehicle, and
an imaging area of the second camera includes at least part of a left side portion of the front end portion of the vehicle.

9. The information presentation device of claim 1, wherein
the vehicle outside imager includes:
a first wide-angle camera located at a portion of a left side of the vehicle; and
a second wide-angle camera located at a portion of a right side of the vehicle,
an imaging area of the first wide-angle camera includes areas to a left of, in front of, and behind the vehicle, and
an imaging area of the second wide-angle camera includes areas to a right of, in front of, and behind the vehicle.

10. The information presentation device of claim 1, wherein the display includes a first display located in front of and to a left of the driver, and a second display located in front of and to a right of the driver.

11. The information presentation device of claim 1, wherein the display includes a first display region located in front of and to a left of the driver, and a second display region located in front of and to a right of the driver.

12. The information presentation device of claim 1, further comprising a speaker,
wherein the information presentation controlling circuitry causes the speaker to output a sound for alerting for the recognized obstacles.

13. An information presentation control method comprising:
recognizing one or more obstacles from a vehicle outside image generated by imaging an area around a vehicle, and generating obstacle information indicating a result of the recognition of the obstacles,
generating line-of-sight information indicating a direction of a line of sight of a driver, from a vehicle inside image generated by imaging an inside of the vehicle, and
making a determination regarding display on each of a plurality of display portions, on a basis of the obstacle information and the line-of-sight information, and controlling display on each of the plurality of display portions, on a basis of the determination,
wherein the determination regarding the display includes, for each of the plurality of display portions, a determination as to whether display of the vehicle outside image on the display portion is needed, and a determination regarding emphasis processing to each obstacle in the vehicle outside image on the display portion,
wherein the determination regarding the emphasis processing includes a determination as to whether emphasis is needed, and a determination of a level of emphasis, and
wherein for each of the recognized one or more obstacles, an image including the obstacle is caused to be displayed on one of the plurality of display portions that is located in a direction of the obstacle or a direction close thereto as viewed from the driver.

14. A non-transitory computer-readable recording medium storing a program for causing a computer to execute a process of the information presentation control method of claim 13.
